(19) United States
(12) Patent Application Publication
(10) Pub. No.: US 2018/0292336 A1
(43) Pub. Date: Oct. 11, 2018

(54) TEMPERATURE DIFFERENTIAL FLUID SENSOR

(71) Applicant: PROVTAGAREN AB, Hässleholm (SE)

(72) Inventors: Daniel Ottosen, Lund (SE); Gunnar Skarping, Hässleholm (SE); Marianne Skarping, Hässleholm (SE)

(21) Appl. No.: 15/762,884

(22) PCT Filed: Sep. 23, 2016
(86) PCT No.: PCT/SE2016/050903

§ 371 Date: Mar. 23, 2018

(30) Foreign Application Priority Data
Sep. 25, 2015 (SE) 1551233-8

(51) Int. Cl. G01N 25/48; B01D 53/04; B01J 20/20; B01J 20/02

(52) U.S. Cl. CPC G01N 25/4806; B01D 53/0407; B01J 20/205; B01J 20/0233; A62B 9/006; B01D 2253/1122; B01D 2257/7027; B01D 2257/602; B01D 2259/4541; B01D 2253/102

(57) ABSTRACT

A fluid detecting device for detecting the presence of a substance in a fluid in an area comprising: a heating element arranged in said area, a first thermal sensor arranged adjacent to said heating element adapted to detect a temperature (T1) at said heating element, wherein said heating element is coated with a hydrophobic sorbent adapted to adsorb a substance present in said fluid in said area. The invention further relates to a method for detecting the presence of a substance in a fluid in an area.

### TECHNICAL FIELD

The present invention relates generally to a method for controlling a fluid detecting device for detecting the presence of a substance in a fluid in an area. More particularly, the present invention relates to a fluid detecting device as defined in the introductory parts of claim 1 and to a method device for detecting the presence of a substance in a fluid in an area as defined as defined in the introductory parts of claim 13.

### BACKGROUND ART

When working in environments where risks of having toxic substances present in a fluid as air or a fluid, it is necessary to either have a sensor warning personnel if a toxic substance is detected or that the personnel use protective gear as gas masks or liquid impermeable clothes.

Sensors for detecting toxic substances in gas are often expensive and must be serviced at certain time intervals. Gas masks often have filters that have to be replaced frequently. A reason for the frequent replacement of filters in gas masks is that the lifetime of the filter has to be set so that the filter never malfunctions, since it is not possible to know if a filter is malfunctioning until it is too late. The replacement of filers in gas masks is however both time consuming and expensive, since the filters themselves are expensive. The functioning of the filter is the only way for the user to ensure that he is safe from toxic substances. However, potential leakage due to a badly fit of the mask to the face of the user is also possible. In that case, the quality of the filter is not important anymore and the user may be exposed to the toxic substances in spite having a new filter in the gas mask.

In liquids it is desired to monitor toxics for work safety reasons but also e.g. in pools and other liquid reservoirs that should be non-hazardous to humans or animals.

There is thus a need for improvements in the field of detecting hazardous gases or liquids in working or living environments, both when it comes to detectors used such environments for warning for hazardous fluids and when it comes to improving the interval of changing gas mask filters.

### SUMMARY OF THE INVENTION

It is an object of the present invention to improve the current state of the art, to solve the above problems, and to provide an improved fluid detecting device that is cheap and may be used in work environments and/or in gas masks. These and other objects are achieved by a fluid detecting device for detecting the presence of a substance in a fluid in an area comprising: a heating element arranged in said area, a first thermal sensor arranged adjacent to said heating element adapted to detect a temperature at said heating element, wherein said heating element is coated with a hydrophobic sorbent adapted to adsorb a substance present in said fluid in said area. A control unit is preferably present connected to the thermal sensor and/or the heating element, wherein the control unit is adapted to provide an output signal. The heating element is heated by providing it with a current. The thermal sensor will sense the fluid temperature adjacent to the heating element. If the substance is adsorbed by the hydrophobic sorbent covering the heating element, the substance will absorb some of the heat that would otherwise heat the surrounding fluid, resulting in a lower temperature at the thermal sensor. The fluid detecting device may then provide an output signal indicating that the substance is present. The signal may e.g. be adapted to warn people near the sensor that the substance is present, e.g. via light signal, an audio signal or by sending a message to a further device. The signal may also be proportional to the difference between the expected temperature and the temperature reported by the thermal sensor thereby estimating the concentration of the substance.

It is important that the hydrophobic sorbent coating of the thermal element is hydrophobic, since it would otherwise adsorb moisture from the air, making detection of the desired substance impossible.

The detecting device may be placed on a wall of room as a gas warning system for people working there or a as a dosimeter for monitoring a substance.

According to a further aspect of the present invention the fluid detecting device further comprises a second thermal sensor adapted to detect a second temperature at said heating element.

The second thermal sensor may be adapted to measure the ambient temperature, unaffected, or at least less affected, by the heating element. The difference between the first and second thermal sensor will thus be less when a substance is adsorbed by the hydrophobic sorbent than if no substance is adsorbed by the hydrophobic sorbent.

The second thermal sensor may be arranged adjacent to and on the opposite side of said thermal element in relation to said first thermal sensor. The second thermal element may be used to measure a difference in temperature between the first and second thermal sensor, which may be useful if the fluid detecting device is placed in a flow of air. The first thermal element and the second thermal sensor are in that case preferably placed so that one thermal sensor is placed downstream the heating element and the other thermal sensor is placed upstream the heating element. The downstream thermal sensor may then measure the fluid temperature and the upstream thermal sensor will measure the fluid temperature that is heated by the heating element. A sudden decrease in the temperature measured at the upstream thermal sensor while no decrease in temperature is detected at the downstream thermal sensor will mean that said substance has been adsorbed in the hydrophobic sorbent and that the substance absorbs some of the heat from the heating element.

According to a still further aspect of the present invention the fluid detecting device further comprises a second heating element arranged in said area at a predetermined distance from said heating element, a third thermal sensor arranged adjacent to said second heating element adapted to detect a third temperature at said second heating element. Said predetermined distance is substantially larger than the distance between said heating element and said first temperature sensor. The second heating element is not coated with a hydrophobic sorbent and will thus not adsorb said substance if present in the fluid. When said substance is not present and if the second thermal element is heated equally to the first, the first thermal sensor and the third thermal sensor will detect substantially the same temperature. If said substance is adsorbed in the hydrophobic sorbent coating of the first thermal sensor will detect a lower temperature than the third thermal sensor since some energy will be used to heat the adsorbed substance.

According to a still further aspect of the present invention the fluid detecting device further comprises a fourth thermal sensor adapted to detect a fourth temperature at said second heating element, said fourth thermal sensor being arranged adjacent to and on the opposite side of said second thermal element in relation to said third thermal sensor. The fluid detecting device may further be placed in a flow channel and said area is a section of the flow channel, said first thermal sensor being arranged upstream of said thermal element, and said second thermal sensor being arranged downstream of said thermal element. The third thermal sensor may be arranged upstream of said second thermal element, and said fourth thermal sensor being arranged downstream of said second thermal element in said flow channel. The second heating element together with the third thermal sensor and the fourth thermal sensor may in then be used as a differential mass flow meter and may be used together with the first heating element, the first thermal sensor and the second thermal sensor for calculating a concentration of the detected substance.

According to a still further aspect of the present invention the sorbent of the fluid detecting device is carbon or a molecular sieve with pores. The sorbent may further be a nanostructure based on carbon having hydrophobic properties, e.g. a graphitized carbon nano-particle layer.

According to a still further aspect of the present invention said substance is a hydrocarbon. The substance may e.g. be benzene.

According to a still further aspect of the present invention the sorbent is gold for adsorbing the substance mercury vapor.

The invention further relates to a method for detecting the presence of a substance in a fluid in an area, comprising measuring a temperature of said fluid at a first point of time (T1-1) by means of a thermal sensor arranged in said area, providing heat by means of a heating element arranged adjacent to said thermal sensor, said heating element being coated with a hydrophobic sorbent adapted to adsorb a substance present in said fluid, measuring said temperature of said fluid at a second point of time (T1-2) by means of said thermal sensor (5), determining the potential presence of said substance based on the temperature difference in temperature between said first point of time (T1-1) and said second point of time (T1-2), and a known input of power provided to said heating element.

If there is no substance adsorbed in the hydrophobic sorbent coating and there the second temperature will be higher than it would be if substance is adsorbed in the coating. The method may incorporate a predetermined calibration so as to evaluate the temperature at the second point of time to a value of how much of the substance that has been adsorbed up until the heating is applied to the heating element.

According to the method described, the fluid detecting device is thus first inactive for a time period, adsorbing any substance present in the air, gas or liquid, before the heating element is actuated and the temperature is measured at the second point in time to determine the amount of substance that is adsorbed in the hydrophobic sorbent. The length of the inactive period will determine the sensitivity of the fluid detection and will have to be accounted for in the pre-made calibration.

According to a still further aspect of the present invention said step of providing heat comprises raising the temperature of said heating element to the vaporization temperature of said substance. Since a lot of energy is required in the vaporization, the measurement will be a lot more precise in that way. When the substance is vaporized, the temperature measured at the thermal sensor will decrease a lot compared to when the substance is not vaporizing. It would also be possible to detect more than one substance, since the vaporization of each substance would occur at different temperatures of the heating element.

According to a still further aspect of the present invention the method for detecting the presence of a substance in a fluid flow inside a flow channel, further comprises measuring a first temperature (T1) of said fluid flow upstream of a heating element coated with a sorbent within said flow channel, said sorbent being adapted to adsorb a substance present in said fluid flow inside said flow channel, providing heat by means of said heating element, measuring a second temperature (T2) of said fluid flow downstream of said heating element within said flow channel, determining the potential presence of said substance based on the temperature difference between said first temperature and said second temperature, and a known mass flow of said fluid flow. If no substance is present the fluid detecting method will function as a differential mass flow meter. When the mass flow is known, e.g. by providing a differential a differential mass flow meter near the fluid detection area, the difference between the detected mass flow and the fluid sensing method may be converted to a concentration of adsorbed substance in the hydrophobic sorbent. When the temperature is raised above the vaporization temperature, the energy that is lost, i.e. would otherwise have been detected at the second thermal sensor, can be translated to a concentration of the substance. The step of determining the potential presence of said substance is thus based on an increased heat capacity of said coated sorbent when said substance is adsorbed to said sorbent and the mass of said substance may be determined based on said temperature difference.

The invention further relates to the use of a fluid detecting device according what has been described, for detecting a potential leak of a substance into a gas mask. The use of the fluid detecting device in a gas mask will warn the user if the mask leaks due to a bad fit of the mask to the face or if the filter is failing. Since the fluid detecting device may be made very sensitive, the filter may be used until it is detected to not function any more, saving a lot of costs.

The invention further relates to the use of a fluid detecting device according to what has been described, for detecting a substance in a gas outlet or inlet to a facility intended for breathing humans or animals. The fluid detecting device may e.g. be placed as a warning system warning people inside a facility if a toxic substance is present in the air of the facility.

Still further the invention relates to the use of a fluid detecting device according to what has been described, for detecting a substance in a liquid, said device further comprising evacuation means to, at least temporary, evacuate said liquid from said area to subsequently operate said fluid detecting device. In case the fluid detecting device is placed in a pipe where liquid is transported, the evacuation device could comprise two valves, one at each side of the fluid detecting device in the pipe, and a pump. When the pipe is filled with liquid the hydrophobic sorbent coated on the heating element will adsorb any substance present in the liquid that is probed for. To detect the substance, the valves are closed and the volume in between, where the fluid detecting device is located, is evacuated from liquid by the pump. When the liquid is removed, the fluid detecting device may be used as described above to measure the presence of the substance adsorbed by the hydrophobic sorbent. It is understood that any other suitable evacuation means may be used. The liquid could e.g. also be evacuated by pressurized air.

When measuring in liquid the substance may be any substance that is solved in the liquid that can be adsorbed by the hydrophobic sorbent. It should also be noted that once the collected substance is released in gas form for measurement when heating the heating element, also a secondary measurement device could be used for determining the nature of the substance if the fluid detecting device itself could not determine it fully.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

### BRIEF DESCRIPTION OF THE DRAWINGS

The above objects, as well as additional objects, features and advantages of the present invention, will be more fully appreciated by reference to the following illustrative and non-limiting detailed description of preferred embodiments of the present invention, when taken in conjunction with the accompanying drawings, wherein:

FIG. 1a is a schematic view of a simple fluid detecting device according to the invention having only one thermal sensor.

FIG. 1b is a schematic view of a simple fluid detecting device according to the invention having two thermal sensors.

FIG. 2 is a schematic view of a fluid detecting device according to the invention intended to be placed in a gas flow.

FIG. 3 is a schematic view of a fluid detecting device according to the invention intended to be placed in a gas flow having a second thermal sensor.

### DETAILED DESCRIPTION OF PREFERRED EMBODIMENTS OF THE INVENTION

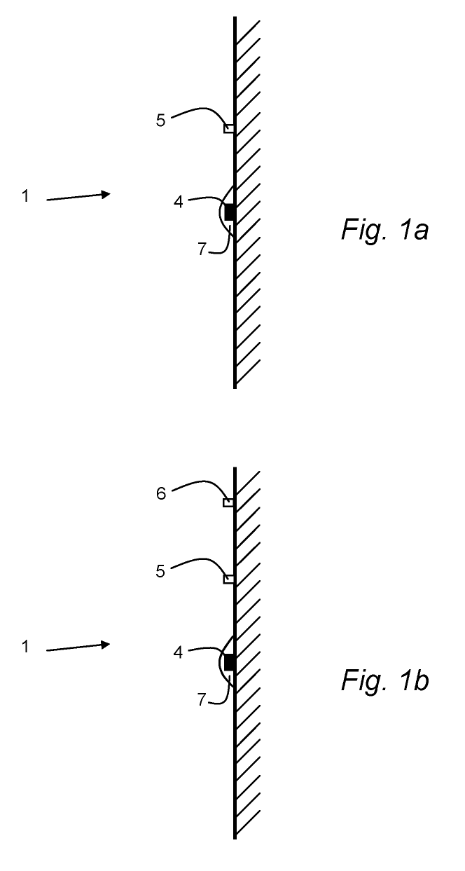

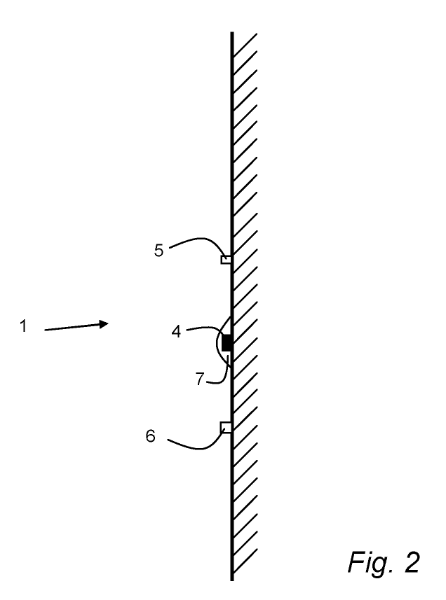

FIG. 1a is a schematic view of a simple fluid detecting device 1 according to the invention having a heating element 4 that is coated with a hydrophobic sorbent 3. A thermal sensor 5 is placed adjacent the heating element. The simple fluid detecting device may be placed on a wall of a room to detect a gaseous substance that is adsorbed by the hydrophobic sorbent. The substance may by e.g. benzene (or another hydrocarbon) if the hydrophobic sorbent is a carbon based nano-structure or mercury is the hydrophobic sorbent is made of gold.

The hydrophobic sorbent coating 3 is adapted to adsorb a substance. At intervals the heating element is actuated and the temperature T1 of the heating element 4 and thus also the temperature of the hydrophobic sorbent 7 is raised. The air surrounding the heating element is naturally also raised via heat conduction from the hydrophobic sorbent. If a substance is adsorbed and present in the hydrophobic sorbent, the substance will absorb some of the heat from the heating element and the temperature measured by the thermal element will be slightly lower. If the temperature of the heating element is raised above the evaporation temperature of the adsorbed substance, the substance will be evaporated, a process requiring a lot of energy, thus leaving less energy for heating the air surrounding the heating element. The temperature elevation measured by the thermal sensor will thus be lower if the substance is present in the hydrophobic sorbent. The temperature elevation at the thermal sensor will thus be dependent on how much heat is adsorbed by the substance and will thereby be dependent of the amount of the substance present in the hydrophobic sorbent. Detection of the substance may thus be achieved. The sensor may further be connected to a warning device, as e.g. a light or a buzzer, to warn people in the area around the sensor that the substance is present. If the substance is benzene, it is hazardous to people and they should thus leave the area or room where the sensor is located.

FIG. 1b shows a schematic view of the simple fluid detecting device 1 shown in FIG. 1a with a second thermal sensor 6, where the second thermal sensor is placed further away from the heating element than the first heating element 5. The second thermal sensor 6 will measure the ambient temperature while the first thermal sensor 5 will measure a temperature that is affected by the heating element 4. With this configuration it is possible to measure continuously to probe for a substance. If the temperature decreases at the first thermal sensor 5 but not at the second thermal sensor 6 some amount of the substance has been adsorbed and evaporated from the hydrophobic sorbent 7.

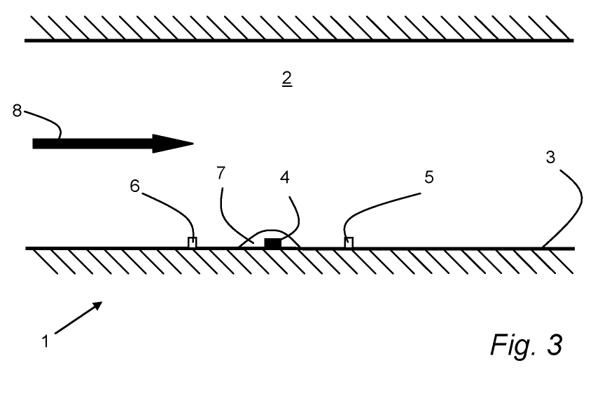

FIG. 2 shows a second configuration of the fluid detecting device 1 of FIG. 1b placed on a wall where the second thermal sensor 6 instead is placed at the same distance from the heating element 4 as first thermal sensor 5 but on the other side of the heating element 4. As heated air from the heating element normally will move upwards, the second thermal sensor 6 will measure the ambient temperature, while the first thermal sensor 5 will measure the temperature that is affected by the heating element 4 and by any substance adsorbed by the hydrophobic sorbent 7.

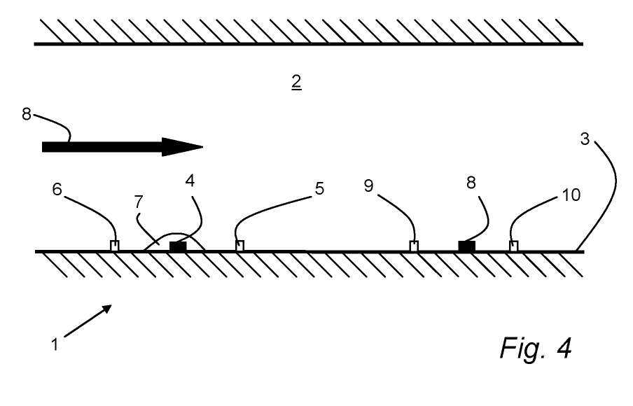

FIG. 3 shows a fluid detecting device 1 placed on the wall 3 of a flow channel 2 in which air is flowing in the direction of the arrow 8. If a substance that is possible to be adsorbed by the hydrophobic sorbent is present in the air the substance will be adsorbed. A first thermal sensor 5 measures the temperature downstream of a heating element. The heating element 4 may at intervals be actuated to raise the temperature of the heating element 4 and the hydrophobic sorbent 7. If substance is present in the hydrophobic sorbent 7, energy will be absorbed by the substance and the temperature T1 measured at the first thermal sensor 5 will be lower than if the substance is not present in the hydrophobic sorbent 7. If the temperature is raised so that the temperature at the hydrophobic sorbent 7 is above the evaporation temperature of the substance, substantially more energy will be required and the temperature at the first thermal sensor will be even lower compared to if no substance is present at the hydrophobic sorbent 7. The second thermal sensor 6, placed upstream the heating element 4, measures the ambient temperature T2 in the gas flow in the flow channel 2 that may be used for determining difference between T1 and T2 and compare it to a calibration. In that way an estimation of the concentration of the substance present in the gas flow 8 may be made.

FIG. 4 shows a fluid detecting device 1 placed on the wall 3 of a flow channel 2 in which air is flowing in the direction of the arrow 8 as the one in FIG. 3 but further comprising a third thermal sensor 9, a second heating element 8, and a fourth thermal sensor 10. The three additional components 8, 9, 10, together form a mass flow meter able to measure the mass flow of the gas flowing through the flow channel 2. When the gas flow is known, the concentration of any substance present in the gas may be calculated from the temperature T1 measured at the first thermal sensor 5 of the fluid detecting device, where the temperature T1 will be affected by the heating element in proportion to the amount of substance adsorbed to the hydrophobic sorbent, if any.

It is understood that other variations in the present invention are contemplated and in some instances, some features of the invention can be employed without a corresponding use of other features. E.g., as also described above, the fluid detecting device could be used in liquids by placing the fluid detecting device in an area where the liquid could be temporary removed when the heating element is operated for detecting adsorbed substance in the sorbent coating. Accordingly, it is appropriate that the appended claims be construed broadly in a manner consistent with the scope of the invention.

1. A fluid detecting device for detecting the presence of a substance in a fluid in an area comprising:
a heating element arranged in said area, and
a first thermal sensor arranged adjacent to said heating element (4) adapted to detect a temperature (T1) at said heating element,
wherein said heating element is coated with a hydrophobic sorbent adapted to adsorb a substance present in said fluid in said area.

2. The fluid detecting device according to claim 1, further comprising:
a second thermal sensor adapted to detect a second temperature (T2) at said heating element, said second thermal sensor being arranged adjacent to and on an opposite side of said thermal element in relation to said first thermal sensor.

3. The fluid detecting device according to claim 2, further comprising:
a second heating element arranged in said area at a predetermined distance from said heating element, and
a third thermal sensor arranged adjacent to said second heating element, said third thermal sensor adapted to detect a third temperature (T3) at said second heating element.

4. The fluid detecting device according to claim 3, further comprising:
a fourth thermal sensor adapted to detect a fourth temperature (T4) at said second heating element, said fourth thermal sensor being arranged adjacent to and on an opposite side of said second heating element in relation to said third thermal sensor.

5. The fluid detecting device according to claim 2, wherein said area is a section of a flow channel,
said first thermal sensor being arranged upstream of said thermal element, and
said second thermal sensor being arranged downstream of said thermal element.

6. The fluid detecting device according to claim 4, wherein said area is a section of a flow channel,
said third thermal sensor being arranged upstream of said second heating element, and
said fourth thermal sensor being arranged downstream of said second heating element.

7. The fluid detecting device according to claim 1, wherein said hydrophobic sorbent is carbon or a molecular sieve with pores.

8. The fluid detecting device according to claim 1, wherein said sorbent is a nanostructure based on carbon having hydrophobic properties.

9. The fluid detecting device according to claim 1, wherein said substance is a hydrocarbon.

10. The fluid detecting device according to claim 1, wherein said substance is benzene.

11. The fluid detecting device according to claim 1, wherein said sorbent is gold.

12. The fluid detecting device according to claim 1, wherein said substance is mercury.

13. A method for detecting the presence of a substance in a fluid in an area, comprising:
measuring a temperature of said fluid at a first point of time (T1-1) by means of a thermal sensor arranged in said area,
providing heat by means of a heating element arranged adjacent to said thermal sensor, said heating element being coated with a hydrophobic sorbent adapted to adsorb a substance present in said fluid,
measuring said temperature of said fluid at a second point of time (T1-2) by means of said thermal sensor, and
determining the potential presence of said substance based on the temperature difference in temperature between said first point of time (T1-1) and said second point of time (T1-2), and a known input of power provided to said heating element.

14. The method for detecting the presence of a substance according to claim 13, wherein
said step of providing heat comprises raising the temperature of said heating element to the vaporization temperature of said substance.

15. Use of the fluid detecting device according to claim 1, for detecting a potential leak of a substance into a gas mask.

16. Use of the fluid detecting device according to claim 1, for detecting a substance in a gas outlet or inlet to a facility intended for breathing humans or animals.

17. Use of the fluid detecting device according to claim 1, for detecting a substance in a liquid, said device further comprising evacuation means to, at least temporary, evacuate said liquid from said area to operate said fluid detecting device.
